(19) United States
(12) Patent Application Publication
(10) Pub. No.: US 2024/0079544 A1
(43) Pub. Date: Mar. 7, 2024

(54) BATTERY CELLS WITH A DUAL-LAYERED CAPACITIVE CABODE ELECTRODE HAVING HIGH CAPACITOR RATIO

(71) Applicant: GM GLOBAL TECHNOLOGY OPERATIONS LLC, Detroit, MI (US)

(72) Inventors: Dewen KONG, Shanghai (CN); Meiyuan WU, Shanghai (CN); Yong LU, Shanghai (CN); Haijing LIU, Shanghai (CN); Mark W. VERBRUGGE, Troy, MI (US)

(21) Appl. No.: 17/961,792

(22) Filed: Oct. 7, 2022

(30) Foreign Application Priority Data
Sep. 2, 2022 (CN) 202211070017.5

(51) Int. Cl. H01M 4/04; H01M 10/04

(52) U.S. Cl. CPC H01M 4/0404; H01M 4/0435; H01M 4/0471; H01M 10/0422; H01M 2010/4292

(57) ABSTRACT

A method for fabricating a dual-layer capacitive cabode electrode includes fabricating a first film including capacitive active material; fabricating a second film including cathode active material; hot jointing the first film and the second film to create a cabode film; and laminating the cabode film onto opposite sides of a current collector using conductive adhesive.

### CROSS-REFERENCE TO RELATED APPLICATIONS

This application claims the benefit of Chinese Patent Application No. 202211070017.5, filed on Sep. 2, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells with a dual-layered capacitive cabode electrode having high capacitor ratio.

Low voltage automotive battery systems such as 12V or 24V battery systems can be used for starting vehicles including an internal combustion engine (ICE) and/or to support vehicle accessory loads or other vehicle systems for these types of vehicles. Low voltage automotive battery systems can also be used to support vehicle accessory loads in electric vehicles (EVs) such as battery electric vehicles, hybrid vehicles and/or fuel cell vehicles. In some applications, the battery systems use lithium-ion battery cells due to their increased pulsed power density at both warm and cold temperatures and lower weight.

During starting, the battery system supplies current to a starter to crank the engine. When the vehicle is cold started, the battery needs to supply sufficient cranking power to overcome the pressure resistance at the top of the piston to start spark-ignition for gasoline engine or create sufficient heat in the cylinder to ignite the injected fuel for a diesel engine. In some applications, the battery system may continue to supply power for various electrical systems of the vehicle after the engine is started. An alternator or regeneration recharges the battery system.

### SUMMARY

A method for fabricating a dual-layer capacitive cabode electrode includes fabricating a first film including capacitive active material; fabricating a second film including cathode active material; hot jointing the first film and the second film to create a cabode film; and laminating the cabode film onto opposite sides of a current collector using conductive adhesive.

In other features, the first film and the second film are free-standing films. The first film has a thickness greater than 50 μm. A capacitor ratio of the dual-layered capacitive cabode electrode is greater than 5%. The capacitive active material is selected from a group consisting of carbon, a metal oxide, a polymer, and combinations thereof. The cathode active material is selected from a group consisting of rock salt layer oxide, a spinel compound, and an olivine compound, a tavorite compound, and combinations thereof.

In other features, the first film includes the capacitive active material, a first polymer powder, and a first processing solvent, and the second film includes the cathode active material, a second polymer powder, and a second processing solvent.

In other features, at least one of the first polymer powder and the second polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof. At least one of the first processing solvent and the second processing solvent is selected from a group consisting of alcohol, ester, and water.

A method for fabricating a dual-layered capacitive cabode electrode includes fabricating a first capacitive film and a second capacitive film that include a capacitive active material; laminating the first capacitive film onto a first side of a current collector; laminating the second capacitive film onto a second side of the current collector to create a capacitive electrode; coating a first side of the capacitive electrode with a slurry including a cathode active material to create a first layer; and coating a second side of the capacitive electrode with the slurry to create a second layer.

In other features, the first capacitive film and the second capacitive film are free-standing films. The first capacitive film and the second capacitive film have a thickness greater than 50 μm. A capacitor ratio of the dual-layered capacitive cabode electrode is greater than 5%. The capacitive active material is selected from the group consisting of carbon, a metal oxide, a polymer, and combinations thereof. The cathode active material is selected from the group consisting of rock salt layer oxide, a spinel compound, and an olivine compound, a tavorite compound, and combinations thereof. The first capacitive film and the second capacitive film include the capacitive active material, a polymer powder, and a processing solvent.

In other features, the polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof. The processing solvent is selected from a group consisting of alcohol, ester, and water.

A method for fabricating a dual-layer capacitive cabode electrode includes fabricating a cathode electrode including cathode active material and a current collector using a wet-coating process; fabricating a first capacitive film and a second capacitive film that include a capacitive active material; laminating the first capacitive film onto a first side of the cathode electrode using a conductive adhesive; and laminating the second capacitive film onto a second side of the cathode electrode using the conductive adhesive.

In other features, the first capacitive film and the second capacitive film are free-standing films. The first capacitive film and the second capacitive film have a thickness greater than 50 μm.

In other features, a capacitor ratio of the dual-layered capacitive cabode electrode is greater than 5%. The capacitive active material is selected from a group consisting of carbon, a metal oxide, a polymer, and combinations thereof. The cathode active material is selected from a group consisting of rock salt layer oxide, a spinel compound, and an olivine compound, a tavorite compound, and combinations thereof.

In other features, the first capacitive film and the second capacitive film includes the capacitive active material, a polymer powder, and a processing solvent. The polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof. The processing solvent is selected from a group consisting of alcohol, ester, and water.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of an example of a battery cell including anode electrodes and dual-layered capacitive cabode electrodes in a stacking cell architecture according to the present disclosure;

FIG. 2 is a cross-sectional view of an example of a dual-layered capacitive cabode electrode in the battery cell of FIG. 1 according to the present disclosure;

FIG. 3 is a cross-sectional view of an example of an anode electrode in the battery cell of FIG. 1 according to the present disclosure;

FIG. 4A illustrates a battery cell including a winding cell architecture including anode electrodes and dual-layered capacitive cabode electrodes according to the present disclosure;

FIG. 4B illustrates a pouch battery cell including anode electrodes and dual-layered capacitive cabode electrodes in a winding cell architecture according to the present disclosure;

FIG. 4C illustrates a prismatic battery cell including anode electrodes and dual-layered capacitive cabode electrodes in a winding cell architecture according to the present disclosure;

FIGS. 5A and 5B illustrate a battery cell including a winding cell architecture for cylindrical battery cells including anode electrodes and dual-layered capacitive cabode electrodes according to the present disclosure;

FIG. 6 is a cross-sectional view of another example of a battery cell including pairs of anode electrodes and dual-layered capacitive cabode electrodes according to the present disclosure;

FIG. 7 is a cross-sectional view of an example of a dual-layered capacitive cabode electrode in the battery cell of FIG. 6 according to the present disclosure;

FIG. 8 is a cross-sectional view of an example of an anode electrode in the battery cell of FIG. 6 according to the present disclosure;

FIG. 9 illustrates a method for manufacturing the battery cells with a low capacitor ratio using a wet-coating process;

FIG. 10 is a flowchart of an example of a method for fabricating a dual-layered capacitive cabode electrode with a high capacitor ratio by hot jointing capacitive active material (AM) film and cathode AM film and laminating onto a current collector according to the present disclosure;

FIG. 11 is a flowchart of an example of a method for fabricating a dual-layered capacitive cabode electrode with a high capacitor ratio by laminating a capacitive AM film onto a current collector and coating cathode AM using a wet coating process according to the present disclosure;

FIG. 12 is a flowchart of a method for fabricating a dual-layered capacitive cabode electrode with a high capacitor ratio by providing a wet coated cathode electrode and laminating a capacitive AM film onto the wet coated electrode according to the present disclosure; and

FIGS. 13 and 14 are examples of methods for fabricating a dual-layered capacitive cabode electrode with a high capacitor ratio.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

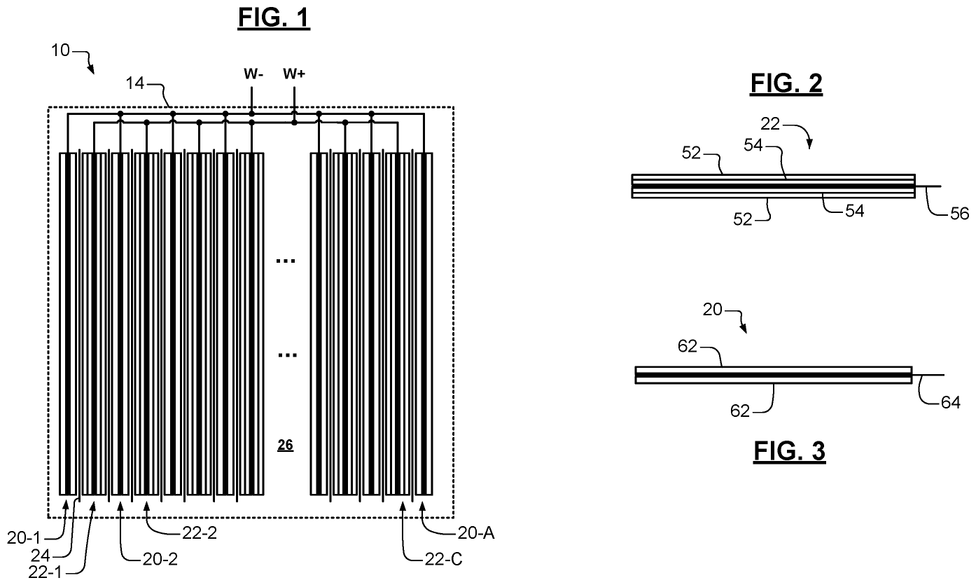

In the description that follows, FIGS. 1-8 describe variations of a dual-layered capacitive cabode having a high capacitor ratio. FIG. 9 describes fabrication of a dual-layered capacitive cabode electrode with low capacitor ratios using a wet coating process. FIGS. 10-14 describe methods for fabricating dual-layered capacitive cabode electrodes with high capacitor ratios according to the present disclosure.

As used herein low capacitor ratio corresponds to capacitor ratios of less than 2%. Higher capacitor ratios allow delivery of higher power levels. As used herein, high capacitor ratio corresponds to capacitor ratios greater than 5%, 6%, 7%, 8%, 9%, 10%, 12%, 15% or higher. The present disclosure relates to dual-layered capacitive cabode and methods for fabricating dual-layered capacitive cabode electrodes having a high capacitor ratios.

The capacitor ratio of the battery cells is related to the thickness of the capacitive active material (AM) layer. Using the processes described below instead of the wet-coating process, the thickness of the capacitive AM layer can be increased to greater than 50 μm, which enables the high capacitor ratio.

In some examples, a dual-layered cabode film is formed by hot-jointing a free-standing capacitive active material film (such as activated carbon (AC)) and a free-standing cathode active material film (such as lithium iron phosphate (LFP)). Then, the cabode film is laminated onto a current collector using conductive adhesive.

In other examples, a free-standing capacitive active material film (such as activated carbon) is laminated onto a current collector using a conductive adhesive to form a capacitive electrode. A cathode active material coating (such as LFP) is applied to outer surfaces of the capacitive electrode.

In other examples, a free-standing capacitive active material film (such as activated carbon) is laminated onto wet coated cathode electrode (such as LFP) using conductive adhesive.

Referring now to FIGS. 1 to 3, a battery cell 10 is arranged in an enclosure 14, and includes anode electrodes 20-1, 20-2, . . . , and 20-A (collectively or individually referred to as anode electrodes 20) and dual-layered capacitive cabode electrodes 22-1, 22-2, . . . and 22-C (collectively or individually referred to as dual-layered capacitive cabode electrodes 22), where A and C are integers greater than zero. In some examples, A is equal to C+1, although other values can be used. The anode electrodes 20 and the dual-layered capacitive cabode electrodes 22 are spaced apart by separators 24 and immersed in electrolyte 26 such as liquid electrolyte or semi solid-state electrolyte. In other words, the separators 24 are arranged between the positive and negative electrodes.

In FIG. 2, the dual-layered capacitive cabode electrodes 22 are shown to include a current collector 56, capacitive active material layers 54 arranged on outer surfaces of the current collector 56, and cathode active material layers 52 arranged on outer surfaces of the capacitive active material layers 54. The capacitive active material layers 54 are located between the cathode active material layers 52 and the current collector 56.

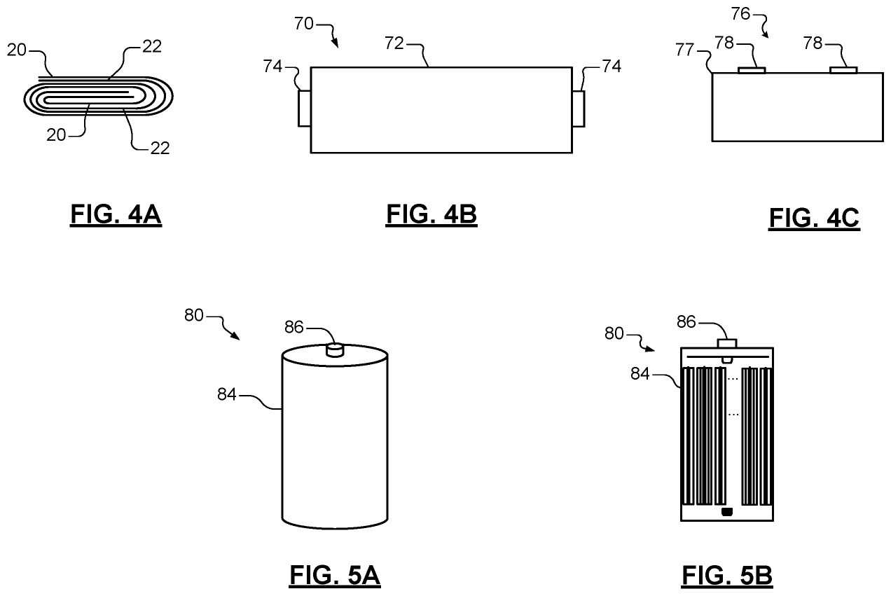

In FIG. 3, the anode electrodes 20 are shown to include a current collector 64 and active material layers 62 arranged on opposite sides of the current collector 64. In some examples, the current collectors 56 and 64 are made of metal foil, meshed foil, or 3D metal foam. In some examples, the current collector 56 is made of aluminum. In some examples, the current collector 64 is made of copper.

As was described above, dual-layered capacitive cabode electrodes having a high capacitor ratios can be achieved using the processes described below. In some examples, the dual-layered cabode film is formed by hot-jointing a free-standing capacitive film (e.g., activated carbon film) and a free-standing cathode film (e.g., LFP). Then, the cabode film is laminated onto a current collector. In other examples, a free-standing capacitive film (e.g., activated carbon film) is laminated onto a current collector to form a capacitive electrode. A cathode coating is applied to outer surfaces of the capacitive electrode.

In some examples, the free-standing films (for the capacitive layer and/or the cathode active material layer) are made of active material, a polymer powder that is fibrillated (e.g., polytetrafluoroethylene (PTFE), fluorinated ethylene propylene (FEP), perfluoroalkoxy alkanes (PFA), ethylene tetrafluoroethylene (ETFE) or a mixed type, and/or a conductive filler. In some examples, powder particle size is D50 in a range from 1 μm to 1000 μm. In some examples, powder particle size is in a range from 1 μm to 50 μm. In some examples, powder particle size is in a range from 1 μm to 10 μm. In some examples, a processing solvent is selected from a group consisting of alcohol, esters, water, or other solvent. In some examples, the solvent has an adding ratio in a range from 5 to 40% mass. In some examples, the solvent has an adding ratio in a range from 10 to 30% mass. In some examples, the film does not include a supportive sheet and in other examples a supportive sheet is used. In some examples, the supportive sheet is made of Polyethylene terephthalate (PET) film.

In some examples, the capacitive layer has a thickness greater than 50 μm. In some examples, single-sided loading of the capacitive active material layers 54 is in a range from 0.05 to 1 mAh/cm², although other values can be used. In other examples, the single-sided loading of the capacitive active material layers 54 is in a range from 0.08 to 0.7 mAh/cm², although other values can be used. In some examples, the press density is in a range from 0.3 to 1 g/cc and the porosity is in a range from 45% to 85%, although other values can be used.

In some examples, the loading of the cathode active material layers 52 is in a range from 0.5 to 3 mAh/cm², although other values can be used. In some examples, the press density of the cathode active material layers 52 is in a range from 1.5 to 3.6 g/cc and the porosity is in a range from 25% to 50%, although other values can be used.

In some examples, the capacitive active material layers 54 include active material comprising carbon materials. In some examples, the carbon materials are selected from a group consisting of activated carbon (AC), graphene, and carbon nanotubes (CNT), although other types of carbon materials can be used. In some examples, the capacitive active material layers 54 include active material comprising metal oxides (MxO_{y}, where x and y are integers greater than zero, O is oxygen, and M is a metal). In some examples, the metal in the metal oxides is selected from a group consisting of cobalt (Co), ruthenium (Ru), and niobium (Nb), although other metals can be used. In other examples, the capacitive active material layers 54 include active material comprising one or more polymers. In some examples, the polymers are selected from a group consisting of polyaniline and polyacetylene, although other polymers can be used. In other examples, the capacitive active material layers 54 can be made using a combination of two or more materials from the same or different groups of materials.

In some examples, the active material of the cathode layers of the cabode electrode include rock salt layered oxides such as LiNiₓMnyCo_{1-x-y}O₂, LiNiₓMn₁₋ₓO₂, Li1+xMO₂, NMC111, NMC523, NMC622, MMC721, or other rock salt layered oxides. In other examples, the active material of the cathode layers of the cabode electrode include spinel compounds such as LiMn₂O₄ or other spinel cathode materials. In other examples, the active material of the cathode layers of the cabode electrode include olivine compounds such as LiV₂(PO₄)₃, LiFePO₄, LiMnₓFe₁₋ₓPO₄ (0<x<1), LiCoPO₄, or other olivine compounds. In other examples, the active material of the cathode layers of the cabode electrode include tavorite compounds such as LiVPO₄F or other tavorite compounds. In other examples, the cathode layers can be made using a combination of two or more materials from the same group or from different groups of the preceding materials.

In some examples, the active material layers 62 of the anode electrodes 20 include carbonaceous materials such as graphite and graphene. In other examples, the active material layers 62 of the anode electrodes 20 comprise silicon (Si)/graphite, lithiated silicon oxide (LSO)/graphite, silicon oxide (SiOₓ)/graphite and/or Si alloy/graphite. In other examples, the active material layers 62 of the anode electrodes 20 comprise lithium titanium oxide such as Li₄Ti₅O₁₂. In other examples, the active material layers 62 of the anode electrodes 20 comprise metal oxides such as vanadium oxide (V₂O₅), lead oxide (SnO), cobalt oxide (Co₃O₄)) or metal sulfides such as iron sulfide (FeS). In other examples, the active material layers 62 of the anode electrodes 20 comprise silicon (Si) and Si alloy, Si/graphite and lithiated Si, and Si alloy and Si/graphite. In other examples, the active material layers 62 of the anode electrodes 20 can be made using a combination of two or more materials from the same group or from different groups of the preceding materials.

In some examples, the separators 24 comprise outer ceramic layers and a polyethylene (PE) layer sandwiched therebetween, although other materials can be used. In other examples, the separators 24 include a microporous polymeric separator including a single layer or a multi-layer laminate fabricated from either a dry or a wet process. For example, a single layer of the polyolefin may form the separator 24. In other examples, the separator 24 includes a fibrous membrane including a plurality of pores extending between the opposing surfaces and having an average thickness of less than a millimeter. In another example, multiple discrete layers of similar or dissimilar polyolefins form a microporous polymer separator. The separator 24 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 24 as a fibrous layer to help provide the separator 24 with appropriate structural and porosity characteristics.

Various conventionally available polymers and commercial products for forming the separator 24 are contemplated, as well as the many manufacturing methods that may be employed to produce such a microporous polymer separator. In some examples, the separator 24 has an average thickness greater than or equal to about 5 μm to less than or equal to about 25 μm, and in certain instances, optionally about 20 μm. In some examples, the separator 24 has an average thickness greater than or equal to 5 μm to less than or equal to 25 μm, and in certain instances, optionally 13 μm. In some examples, the separator 24 includes one or more ceramic materials and/or one or more heat resistant materials. In some examples, the separator materials are admixed with the one or more ceramic materials and/or the one or more heat-resistant materials, or one or more surfaces of the separator 24 are coated with the one or more ceramic materials and/or polymer coating layer and/or the one or more heat resistant materials. The one or more ceramic materials may include, for example, alumina (Al₂O₃), silica (SiO₂), and the like. The heat resistant material may include, for example, Nomex, Aramid, and the like.

Referring now to FIGS. 4A and 4B, the battery cell uses a winding cell architecture in a pouch battery cell. In FIG. 4A, a battery cell 70 includes a pouch enclosure 72 and terminals 74 extending from ends of the pouch enclosure 72. In some examples, the pouch enclosure 72 is made of a flexible material. In FIG. 4B, the winding cell includes the anode electrodes 20 and the dual-layered capacitive cabode electrodes 22 are arranged adjacent to one another and folded at a predetermined intervals as shown. In FIG. 4C, the winding cell of FIG. 4B can also be packaged in as a prismatic battery cell. A battery cell 76 includes an enclosure 77 and terminals 78 extending from ends of the enclosure 77.

Referring now to FIGS. 5A and 5B, the battery cell can be packaged in a winding cell architecture for cylindrical battery cells. A battery cell 80 includes a cylindrical housing 84 including terminals 86, 87.

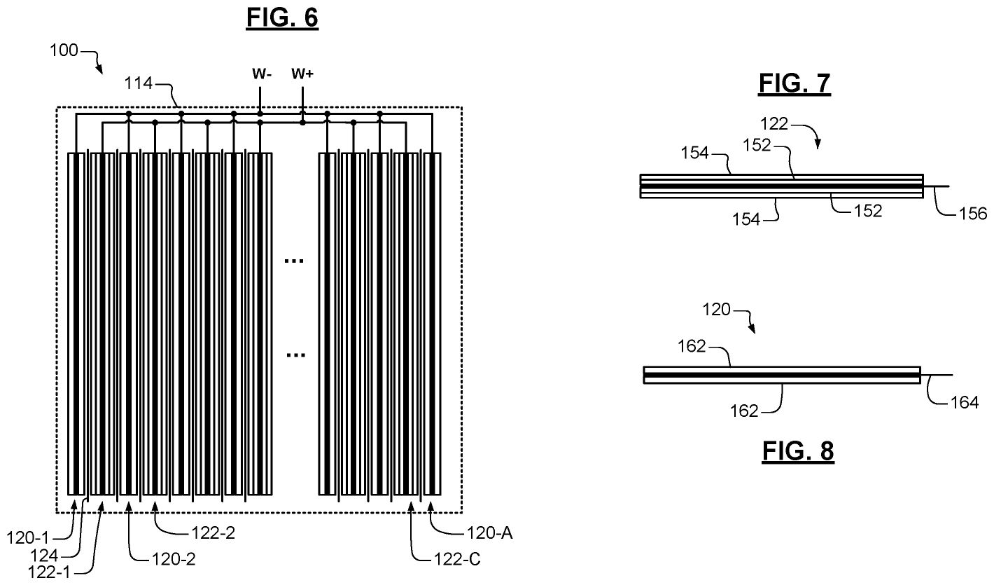

Referring now to FIGS. 6 to 8, another arrangement of the active material layers and the capacitive layers can be used. In this example, the active material layers of the dual-layered capacitive cabode electrodes are located between the capacitive layers and the current collectors. In FIG. 6, a battery cell 100 is arranged in an enclosure 114, and includes anode electrodes 120-1, 120-2, . . . , and 120-A (collectively or individually referred to as anode electrodes 120) and dual-layered capacitive cabode electrodes 122-1, 122-2, . . . and 122-C (collectively or individually referred to as dual-layered capacitive cabode electrodes 122), where A and C are integers greater than zero. In some examples, A is equal to C+1, although other values can be used. The anode electrodes 120 and the dual-layered capacitive cabode electrodes 122 are spaced apart by separators 124 and immersed in electrolyte such as liquid electrolyte or semi solid-state electrolyte.

In FIG. 7, the dual-layered capacitive cabode electrodes 122 are shown to include a current collector 156, active material layers 152 arranged on outer surfaces of the current collector 156, and capacitive layers 154 arranged on outer surfaces of the active material layers 152. The active material layers 152 are located between the capacitive layers 154 and the current collector 156.

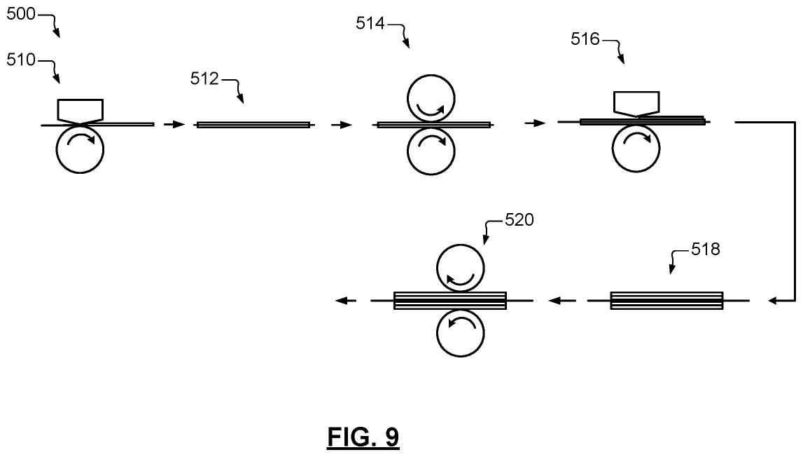

In FIG. 8, the anode electrodes 20 are shown to include a current collector 64 and active material layers 62 arranged on opposite sides of the current collector 64.

Referring now to FIG. 9, a method 500 for manufacturing the battery cells with dual-layered capacitive cabode electrodes having low capacitor ratios is illustrated. At 510 and 512, the current collector is coated with a capacitive layer (e.g., activated carbon or other material) and then dried. At 514, the capacitive layer is pressed. At 516 and 518, the active material layer (e.g., LFP or other material) is coated over the capacitive layer and dried. At 520, the active material layer is pressed. Further processing such as notching stacking/winding, injection, formation and/or other steps are performed. As can be appreciated, a similar process can be used for the battery cells with dual-layered capacitive cabode electrodes of FIGS. 6-8) by rearranging the order of the coating steps.

As described above, the wet coating method can current produce dual-layered capacitive cabode electrodes with low capacitor ratios since the thickness of the capacitive AM layers is limited. FIGS. 10-14 described below relate to methods for producing dual-layered capacitive cabode electrodes with high capacitor ratios. The processes described below can produce capacitive AM layers with a thickness greater than or equal to 50 μm.

Referring now to FIG. 10, an example of a method 620 for producing dual-layered capacitive cabode electrodes with a high capacitor ratio is shown. At 622, hot jointing is used to join a free-standing capacitive active material (AM) film (such as activated carbon) and a free-standing cathode AM film (such as LFP) to create cabode film. At 626, the cabode film is laminated onto opposite sides of a current collector using conductive adhesive.

In some examples, the free-standing capacitive AM film has a thickness of 110 μm, a press density of 0.5 g/cc, loading of 0.17 mAh/cm², and a formulation of AC/SP/PTFE=95/2/3 at mass ratio.

In some examples, the free-standing cathode AM film includes LFP having a thickness of 110 μm, a press density of 1.5 g/cc, a loading of 2.1 mAh/cm², and a formulation of LFP/SP/CNT/PTFE of 92/4.8/0.2/3 at mass ratio. In this example, the capacitor ratio is about 7.5%. SP represents carbon black Super-P is a product of TIMCAL, which was used as conductive agent in the electrode. Referring now to FIG. 11, another method 630 for producing dual-layered capacitive cabode electrodes with a high capacitor ratio is shown. At 632, a free-standing capacitive AM film is laminated onto opposite sides of a current collector. At 636, a slurry with cathode active material is provided. At 638, opposite sides of the laminate (including the capacitive AM film and the current collector) is coated with the active material slurry.

In some examples, the free-standing capacitive AM film has a thickness of 110 μm, a press density of 0.5 g/cc, loading of 0.17 mAh/cm², and a formulation of AC/SP/PTFE=95/2/3 at mass ratio. In some examples, the wet coated cathode AM layer includes LFP having a thickness of 46 μm, a press density of 1.9 g/cc, a loading of 1.1 mAh/cm² and a formulation of LFP/SP/CNT/PVDF of 92/4.8/0.2/3 at mass ratio.

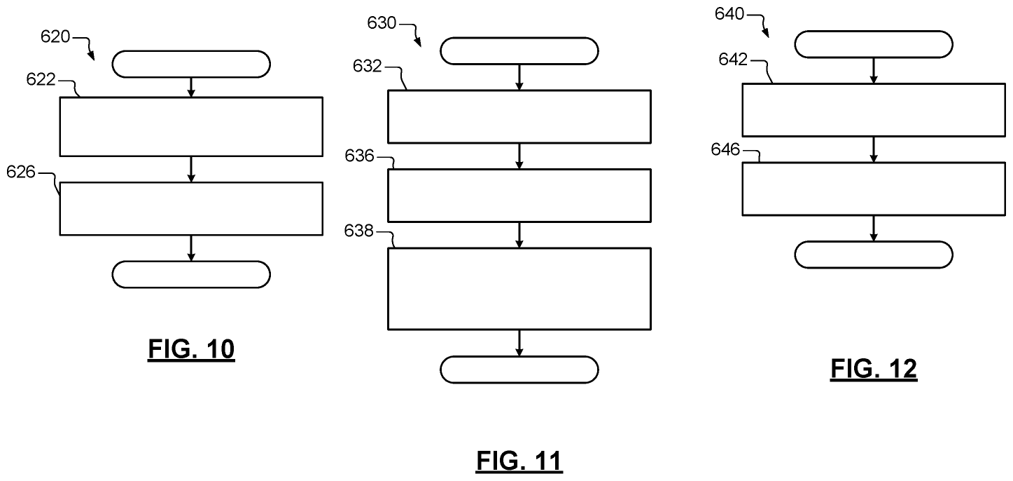

Referring now to FIG. 12, another method 640 for producing dual-layered capacitive cabode electrodes with a high capacitor ratio is shown. At 642, a wet-coated cathode electrode (such as LFP) (including cathode AM and a current collector) and a free-standing capacitive AM film (such as activated carbon) are provided. At 646, the free-standing capacitive AM film is laminated onto the wet coated cathode electrode using conductive adhesive.

In some examples, the wet-coated cathode electrode includes LFP having a thickness of 46 μm, a press density of 1.9 g/cc, a loading of 1.1 mAh/cm², and has a formulation of LFP/SP/CNT/PVDF=94/4.8/0.2/3 at mass ratio. In some examples, the free-standing capacitive AM film includes activated carbon having a thickness of 110 μm, a press density of 0.5 g/cc, a loading of 0.17 mAh/cm², and a formulation of AC/SP/PTFE of 95/2/3 at mass ratio.

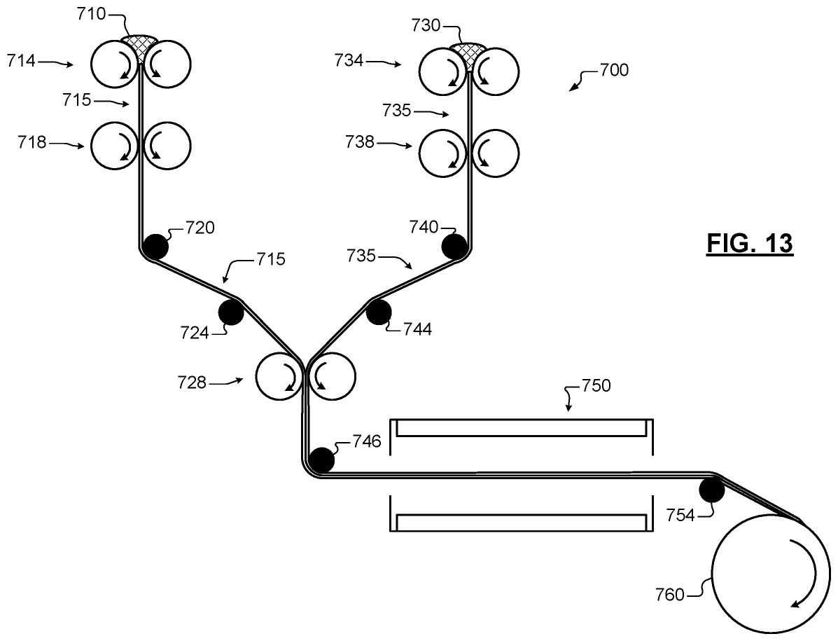

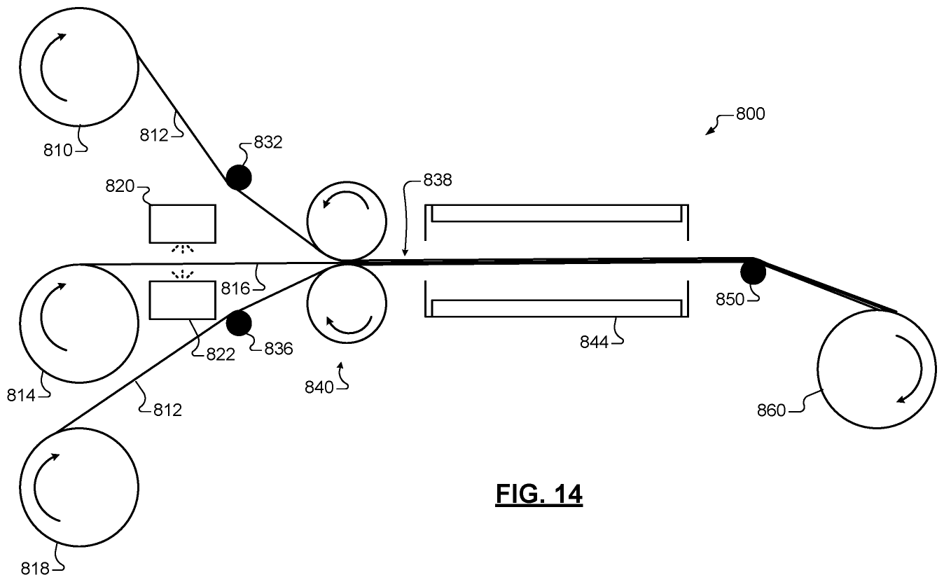

Referring now to FIG. 13, a method 700 for producing a free-standing cabode film is shown. A mixture 710 is supplied above a pair of rollers 714. In some examples, the mixture includes capacitive active material (such as activated carbon), conductive filler and a polymer powder. The polymer powder can be fibrillated (e.g., polytetrafluoroethylene (PTFE), fluorinated ethylene propylene (FEP), perfluoroalkoxy alkanes (PFA), ethylene tetrafluoroethylene (ETFE) or a mixed type.

The pair of rollers 714 apply pressure and/or heat to the material to create a self-standing capacitive AM film 715. An additional pair of rollers 718 may be used to apply additional pressure and/or heat to the self-standing capacitive AM film 715. One or more guide rollers 720 and 724 direct the self-standing capacitive AM film 715 to a pair of rollers 728 that apply heat and/or pressure.

A mixture 730 is supplied above a pair of rollers 734. In some examples, the mixture includes cathode active material, conductive filler and a polymer powder. The pair of rollers 734 apply pressure and/or heat to the mixture to create a self-standing cathode AM film 735. An additional pair of rollers 738 may be used to apply additional pressure and/or heat. One or more guide rollers 740 and 744 direct the self-standing cathode AM film to the pair of rollers 728. The pair of rollers 728 applies pressure and/or heat to the capacitive AM film and the cathode AM film to create a self-standing cabode film. One or more guide rollers 746 redirect the cabode film through a heater 750. In some examples, the heater 750 operates at a temperature in a range from 100° C. to 190° C. One or more guide rollers 754 guide the self-standing cabode film onto a film roll 760.

Referring now to FIG. 14, a method 800 for producing dual-layered capacitive cabode electrodes with high capacitor ratios using the cabode film is shown. A roll 810 of self-standing cabode film 812 is guided by one or more guide rollers 832 between a pair of rollers 840. A roll 814 of collector current foil 816 is guided by one or more guide rollers 832 between the pair of rollers 840. A roll 818 of the self-standing cabode film 812 is guided by one or more guide rollers 832 between the pair of rollers 840. Prior to reaching the pair of rollers 840, sprayers 820 and 822 apply conductive adhesive to opposite sides of the collector current foil 816 (and/or to facing surfaces of the self-standing cabode film 812).

The pair of rollers 840 apply pressure and/or heat to the self-standing cabode films 812 and the collector current foil 816 to create a dual-layered capacitive cabode electrode 838. The combined film passes through a heater 844. In some examples, the heater 844 operates at a temperature in a range from 80° C. to 190° C. After heating, the combined dual-layered capacitive cabode electrode 838 passes over one or more guide rollers 850 and onto a roll 860.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for fabricating a dual-layer capacitive cabode electrode, comprising:
fabricating a first film including capacitive active material;
fabricating a second film including cathode active material;
hot jointing the first film and the second film to create a cabode film; and
laminating the cabode film onto opposite sides of a current collector using conductive adhesive.

2. The method of claim 1, wherein:
the first film and the second film are free-standing films; and
the first film has a thickness greater than 50 μm.

3. The method of claim 1, wherein a capacitor ratio of the dual-layered capacitive cabode electrode is greater than 5%.

4. The method of claim 1, wherein the capacitive active material is selected from a group consisting of carbon, a metal oxide, a polymer, and combinations thereof.

5. The method of claim 1, wherein the cathode active material is selected from a group consisting of rock salt layer oxide, a spinel compound, and an olivine compound, a tavorite compound, and combinations thereof.

6. The method of claim 1, wherein:
the first film includes the capacitive active material, a first polymer powder, and a first processing solvent; and
the second film includes the cathode active material, a second polymer powder, and a second processing solvent.

7. The method of claim 6, wherein:
at least one of the first polymer powder and the second polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof; and
at least one of the first processing solvent and the second processing solvent is selected from a group consisting of alcohol, ester, and water.

8. A method for fabricating a dual-layered capacitive cabode electrode, comprising:
fabricating a first capacitive film and a second capacitive film that include a capacitive active material;
laminating the first capacitive film onto a first side of a current collector;
laminating the second capacitive film onto a second side of the current collector to create a capacitive electrode;
coating a first side of the capacitive electrode with a slurry including a cathode active material to create a first layer; and
coating a second side of the capacitive electrode with the slurry to create a second layer.

9. The method of claim 8, wherein:
the first capacitive film and the second capacitive film are free-standing films; and
the first capacitive film and the second capacitive film have a thickness greater than 50 μm.

10. The method of claim 8, wherein a capacitor ratio of the dual-layered capacitive cabode electrode is greater than 5%.

11. The method of claim 8, wherein the capacitive active material is selected from the group consisting of carbon, a metal oxide, a polymer, and combinations thereof.

12. The method of claim 8, wherein the cathode active material is selected from the group consisting of rock salt layer oxide, a spinel compound, and an olivine compound, a tavorite compound, and combinations thereof.

13. The method of claim 8, wherein the first capacitive film and the second capacitive film include the capacitive active material, a polymer powder, and a processing solvent.

14. The method of claim 13, wherein:
the polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof; and
the processing solvent is selected from a group consisting of alcohol, ester, and water.

15. A method for fabricating a dual-layer capacitive cabode electrode, comprising:
fabricating a cathode electrode including cathode active material and a current collector using a wet-coating process;
fabricating a first capacitive film and a second capacitive film that include a capacitive active material;
laminating the first capacitive film onto a first side of the cathode electrode using a conductive adhesive; and
laminating the second capacitive film onto a second side of the cathode electrode using the conductive adhesive.

16. The method of claim 15, wherein:
the first capacitive film and the second capacitive film are free-standing films; and
the first capacitive film and the second capacitive film have a thickness greater than 50 μm.

17. The method of claim 15, wherein a capacitor ratio of the dual-layered capacitive cabode electrode is greater than 5%.

18. The method of claim 15, wherein the capacitive active material is selected from a group consisting of carbon, a metal oxide, a polymer, and combinations thereof.

19. The method of claim 15, wherein the cathode active material is selected from a group consisting of rock salt layer oxide, a spinel compound, and an olivine compound, a tavorite compound, and combinations thereof.

20. The method of claim 15, wherein:
the first capacitive film and the second capacitive film includes the capacitive active material, a polymer powder, and a processing solvent;
the polymer powder is selected from a group consisting of polytetrafluoroethylene (PTFE), fluorinated ethylene propylene (FEP), perfluoroalkoxy alkanes (PFA), ethylene tetrafluoroethylene (ETFE), and combinations thereof; and
the processing solvent is selected from a group consisting of alcohol, ester, and water.
